(19) United States
(12) Patent Application Publication
(10) Pub. No.: US 2025/0208476 A1
(43) Pub. Date: Jun. 26, 2025

(54) ELECTROCHROMIC LENS AND METHOD FOR MANUFACTURING THE SAME

(71) Applicant: FORESIGHT OPTICAL LTD., TAINAN CITY (TW)

(72) Inventors: TIEN-SHU WU, TAINAN CITY (TW); YEN-TING WU, TAINAN CITY (TW)

(21) Appl. No.: 18/391,214

(22) Filed: Dec. 20, 2023

(51) Int. Cl. G02F 1/157; B29D 11/00; G02C 7/10; G02F 1/1523; G02F 1/161; G02F 1/163

(52) U.S. Cl. CPC G02F 1/157; B29D 11/00634; B29D 11/00817; G02C 7/101; G02F 1/1523; G02F 1/161; G02F 1/163; G02F 2202/28

(57) ABSTRACT

An electrochromic lens and a method for manufacturing the same are disclosed. The method includes the following steps: heating a flat substrate and then bending the flat substrate into a curved; providing two curved substrates to be respectively electroplated with indium tin oxide transparent conductive films; arranging the two curved substrates in parallel in a predetermined direction; arranging the indium tin oxide transparent conductive films to face each other in the predetermined direction; providing a leak-proof component between the two curved substrates to form a filling area between the two indium tin oxide transparent conductive films; providing a liquid crystal in the filling area to form an electrochromic module; providing a lens body and attaching the electrochromic module to the lens body. By applying a voltage to the indium tin oxide transparent conductive films, the electrochromic module changes color, thereby changing the light transmittance of the electrochromic lens.

### FIELD OF THE INVENTION

The present invention relates to an electrochromic lens and a manufacturing method thereof, and more particularly to an electrochromic lens capable of changing its light transmittance.

### BACKGROUND OF THE INVENTION

When light is too strong, people wear tinted sunglasses with low light transmission to reduce the amount of light entering the eyes, thus protecting the eyes from injury.

However, most of the sunglasses in the market have a single transparency, which cannot be adjusted to the most suitable transparency for different levels of light intensity.

### SUMMARY OF THE INVENTION

According to one aspect of the present invention, a method for manufacturing an electrochromic lens is provided. The method comprises the following steps: heating a flat substrate at a temperature of between 80° C. and 140° C. for 1 minute to 20 minutes, wherein the flat substrate is made of one of nylon, polycarbonate (PC), polyethylene (PE) and polymethyl methacrylate (PMMA); and then bending the flat substrate into a curved substrate having a thickness between 0.1 mm and 1 mm; providing two said curved substrates, wherein the curved substrates each have a first substrate surface and a second substrate surface opposite to the first substrate surface, the first substrate surface of one of the curved substrates is electroplated with an indium tin oxide transparent conductive film, the second substrate surface of the other one of the curved substrates is electroplated with another indium tin oxide transparent conductive film; arranging the two curved substrates in parallel in a predetermined direction, and arranging the indium tin oxide transparent conductive films of the two curved substrates to face each other in the predetermined direction; providing a leak-proof component between the two curved substrates to form a filling area between the two indium tin oxide transparent conductive films; providing a liquid crystal in the filling area to form an electrochromic module, wherein the electrochromic module has a thickness of between 0.2 mm and 2 mm; providing a lens body that is parallel to the electrochromic module in the predetermined direction, and attaching the electrochromic module to one of lens surfaces of the lens body from the predetermined direction.

According to another aspect of the present invention, an electrochromic lens manufactured by using the foregoing method is provided. The electrochromic lens comprises the lens body and the electrochromic module. The lens body has two opposing lens surfaces. The electrochromic module is parallel to the lens body in the predetermined direction and attached to one of the lens surfaces. The electrochromic module includes the two curved substrates, the two indium tin oxide transparent conductive films, the leak-proof component, the filling area, and the liquid crystal. The two curved substrates are arranged in parallel in the predetermined direction. The curved substrates each have the first substrate surface and the second substrate surface opposite to the first substrate surface. The two indium tin oxide transparent conductive films are electroplated on the first substrate surface of one of the curved substrates and the second substrate surface of the other one of the curved substrates, respectively. The indium tin oxide transparent conductive films of the two curved substrates are arranged facing each other. The leak-proof component is disposed between the two curved substrates. The filling area is formed between the two indium tin oxide transparent conductive films. The liquid crystal is disposed in the filling area. When a voltage is applied to the two indium tin oxide transparent conductive films, the liquid crystal in contact with the indium tin oxide transparent conductive films changes an arrangement and cause the electrochromic module to change a color, thereby indirectly changing a light transmittance of the lens body attached to the electrochromic module.

Preferably, the curved substrate is in the form of one of a spherical surface, a hyperboloid surface, a free-form surface and a cylindrical surface.

Preferably, the electrochromic module is attached to one of the lens surfaces through an optically clear adhesive or a pressure-sensitive adhesive (PSA).

Preferably, a power supply unit is electrically connected to the two indium tin oxide transparent conductive films, and the power supply unit is a solar cell or a lithium battery.

According to the above technical features, the following effects can be achieved:
1. The flat substrate is heated at a temperature of between 80° C. and 140° C. for 1 minute to 20 minutes and then bent into the curved substrate after cooling. The curved substrate has better light transmittance and can be used in combination with the lens without degrading the overall light transmittance of the photochromic lens.
2. When the user wears the eyeglasses with the lenses of the present invention, the light transmittance of the lenses can be adjusted in a timely manner so as to adapt to different levels of light intensity.

3. The lens body and the electrochromic module are bonded together by using the optically clear adhesive. The optically clear adhesive itself has a high light transmittance of more than 90%, which does not affect the overall light transmittance of the electrochromic lens after bonding.

### BRIEF DESCRIPTION OF THE DRAWINGS

FIG. 1 is a side view of the electrochromic lens of the present invention;

FIG. 2 is a cross-sectional of the electrochromic module of the present invention;

FIG. 3 is a block diagram of the electrochromic lens of the present invention; and

FIG. 4 is a flow chart of the method for manufacturing the electrochromic lens of the present invention.

### DETAILED DESCRIPTION OF THE PREFERRED EMBODIMENTS

Embodiments of the present invention will now be described, by way of example only, with reference to the accompanying drawings.

The present invention discloses an electrochromic lens and a method for manufacturing the electrochromic lens.

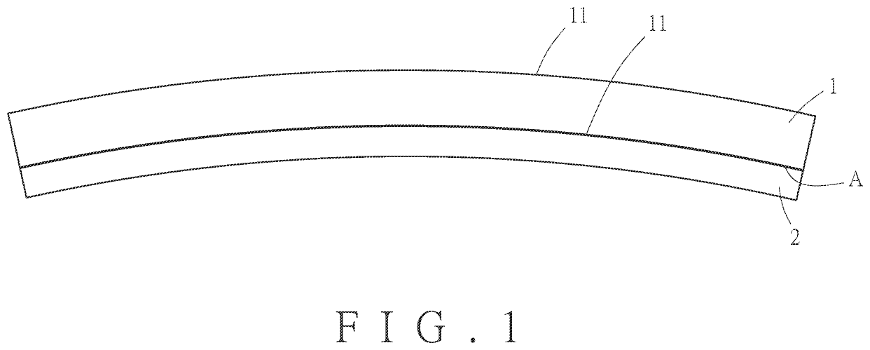

Referring to FIG. 1, the electrochromic lens of the present invention comprises a lens body 1 and an electrochromic module 2.

The lens body 1 has two opposing lens surfaces 11. The electrochromic module 2 is parallel to the lens body 1 in a predetermined direction, and is attached to one of the lens surfaces 11 through an adhesive A. Specifically, the adhesive A is an optically clear adhesive or a pressure-sensitive adhesive (PSA) for attaching the electrochromic module 2 to the lens body 1.

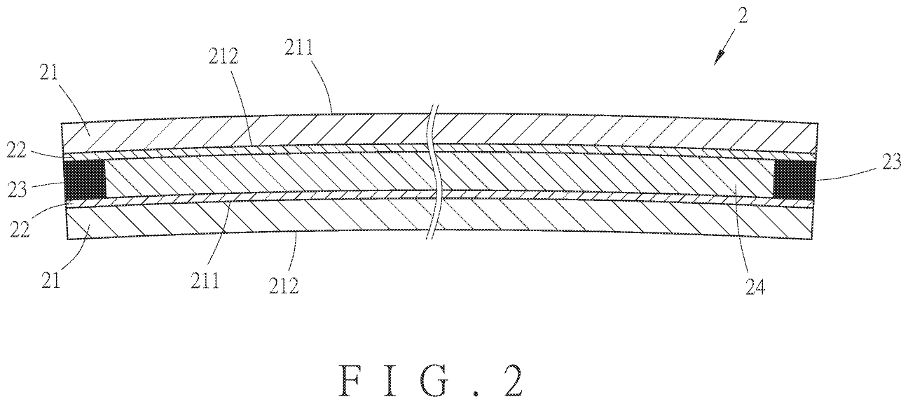

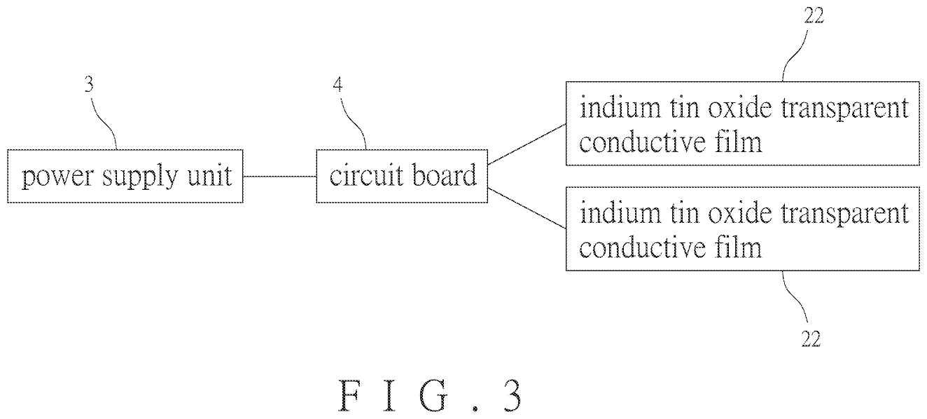

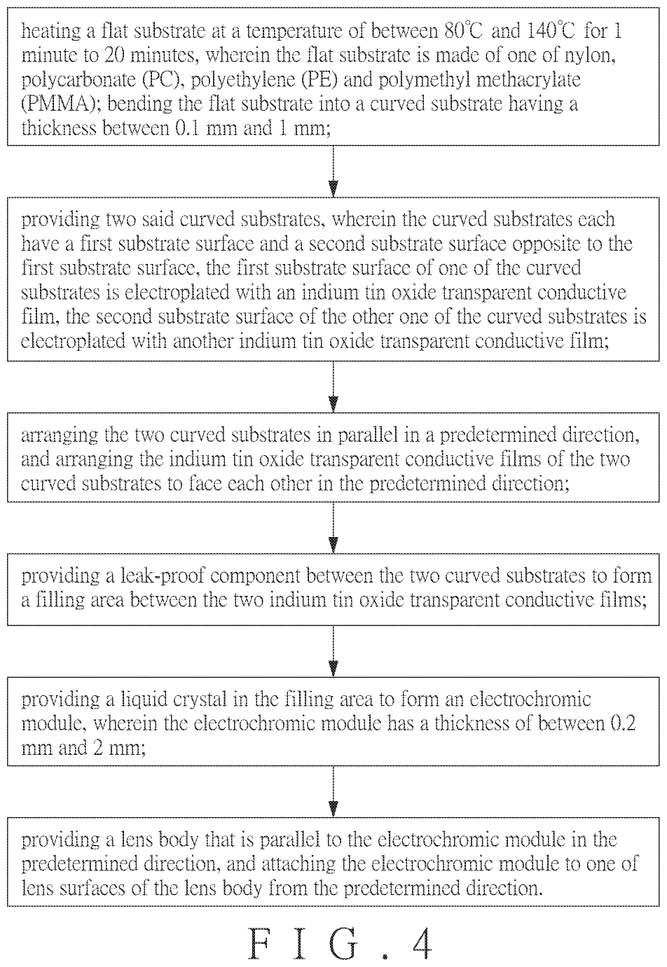

Referring to FIG. 2, FIG. 3 and FIG. 4, the electrochromic module 2 includes two curved substrates 21, two indium tin oxide transparent conductive films 22, a leak-proof component 23, a filling area, a liquid crystal 24, a power supply unit 3, and a circuit board 4. The thickness of the electrochromic module 2 is substantially between 0.2 mm and 2 mm.

The two curved substrates 21 are arranged in parallel in the predetermined direction. In the steps of the method for manufacturing the electrochromic lens of the present invention, a flat substrate is heated. The material of the flat substrate is one of nylon, polycarbonate (PC), polyethylene (PE) and polymethyl methacrylate (PMMA). The heating temperature is between 80° C. and 140° C. The heating time is between 1 minute and 20 minutes. After heating, the flat substrate is bent into the curved substrate 21 with a thickness between 0.1 mm and 1 mm. Specifically, the curved substrate 21 is in the form of one of a spherical surface, a hyperboloid surface, a free-form surface and a cylindrical surface. In this embodiment, the spherical surface is taken as an example, such as a general eyeglass. Others are applied to hyperboloid surfaces, such as ski goggles and the like having a large area. In addition, in the range of the above-mentioned heating temperature and heating time, when the curved substrate 21 is produced, the curved substrate 21 will not melt due to overheating or will not have the problem that the curvature of the curved substrate 21 does not meet the requirement after bending due to insufficient temperature. The curved substrate 21 has good transparency and will not reduce the transparency of the overall photochromic lens after being used in combination with the lens body 1.

The two indium tin oxide transparent conductive films 22 are electroplated on the two curved substrates 21, respectively. In the steps of the method for manufacturing the electrochromic lens of the present invention, two curved substrates 21 are provided. The curved substrates 21 each have a first substrate surface 211 and a second substrate surface 212 opposite to the first substrate surface 211. One of the indium tin oxide transparent conductive films 22 is electroplated on the first substrate surface 211 of one of the curved substrates 21. The other one of the indium tin oxide transparent conductive films 22 is electroplated on the second substrate surface 212 of the other one of the curved substrates 21. Specifically, the first substrate surface 211 is a convex curved surface, and the second substrate surface 212 is a concave curved surface. The two indium tin oxide transparent conductive films 22 are respectively electroplated on the two curved substrates 21 to form a convex curved surface and a concave curved surface. The indium tin oxide transparent conductive films 22 of the two curved substrates 21 are arranged facing each other in the predetermined direction.

The leak-proof component 23 is disposed between the two curved substrates 21 and located at the edges of the curved substrates 21. The filling area is formed between the two indium tin oxide transparent conductive films 22. Specifically, in the steps of the method for manufacturing the electrochromic lens of the present invention, the indium tin oxide transparent conductive films 22 in the form of a convex curved surface and a concave curved surface are arranged facing each other. The leak-proof component 23 and the indium tin oxide transparent conductive films 22 surround the filling area to form a closed filling area. The liquid crystal 24 is disposed in the filling area so that the liquid crystal 24 contacts both the indium tin oxide transparent conductive films 22 of the two curved substrates 21. The power supply unit 3 is electrically connected to the circuit board 4. The circuit board 4 is electrically connected to the two indium tin oxide transparent conductive films 22.

In the present invention, the problem of poor optical performance can be avoided by bending the curved substrate 21 before filling the liquid crystal 24 between the curved substrates 21.

Because the thickness of the curved substrate 21 is substantially between 0.1 mm and 1 mm, the thickness of the indium tin oxide transparent conductive films 22 and the liquid crystal 24 is so thin as to be negligible relative to the curved substrate 21. The thickness of the electrochromic module 2 is substantially between 0.2 mm and 2 mm.

When the electrochromic lens of the present invention is in use, by applying a voltage to the two indium tin oxide transparent conductive films 22 through the power supply unit 3, the liquid crystal 24 in contact with the indium tin oxide transparent conductive films 22 will change its arrangement and cause the electrochromic module 2 to change its color, thereby indirectly changing the light transmittance of the lens body 1 attached to the electrochromic module 2.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A method for manufacturing an electrochromic lens, comprising the following steps:
heating a flat substrate at a temperature of between 80° C. and 140° C. for 1 minute to 20 minutes, wherein the flat substrate is made of one of nylon, polycarbonate (PC), polyethylene (PE) and polymethyl methacrylate (PMMA); bending the flat substrate into a curved substrate having a thickness between 0.1 mm and 1 mm;
providing two said curved substrates, wherein the curved substrates each have a first substrate surface and a second substrate surface opposite to the first substrate surface, the first substrate surface of one of the curved substrates is electroplated with an indium tin oxide transparent conductive film, the second substrate surface of the other one of the curved substrates is electroplated with another indium tin oxide transparent conductive film;
arranging the two curved substrates in parallel in a predetermined direction, and arranging the indium tin oxide transparent conductive films of the two curved substrates to face each other in the predetermined direction;
providing a leak-proof component between the two curved substrates to form a filling area between the two indium tin oxide transparent conductive films;
providing a liquid crystal in the filling area to form an electrochromic module, wherein the electrochromic module has a thickness of between 0.2 mm and 2 mm;
providing a lens body that is parallel to the electrochromic module in the predetermined direction, and attaching the electrochromic module to one of lens surfaces of the lens body from the predetermined direction.

2. An electrochromic lens manufactured by using the method as claimed in claim 1, comprising:
the lens body, having two opposing lens surfaces;
the electrochromic module, parallel to the lens body in the predetermined direction and attached to one of the lens surfaces, the electrochromic module including:
the two curved substrates, arranged in parallel in the predetermined direction, the curved substrates each having the first substrate surface and the second substrate surface opposite to the first substrate surface;
the two indium tin oxide transparent conductive films, electroplated on the first substrate surface of one of the curved substrates and the second substrate surface of the other one of the curved substrates respectively, the indium tin oxide transparent conductive films of the two curved substrates being arranged facing each other;
the leak-proof component, disposed between the two curved substrates;
the filling area, formed between the two indium tin oxide transparent conductive films;
the liquid crystal, disposed in the filling area;
wherein when a voltage is applied to the two indium tin oxide transparent conductive films, the liquid crystal in contact with the indium tin oxide transparent conductive films changes an arrangement and cause the electrochromic module to change a color, thereby indirectly changing a light transmittance of the lens body attached to the electrochromic module.

3. The electrochromic lens as claimed in claim 2, wherein the curved substrate is in the form of one of a spherical surface, a hyperboloid surface, a free-form surface and a cylindrical surface.

4. The electrochromic lens as claimed in claim 2, wherein the electrochromic module is attached to one of the lens surfaces through an optically clear adhesive or a pressure-sensitive adhesive (PSA).

5. The electrochromic lens as claimed in claim 2, wherein a power supply unit is electrically connected to the two indium tin oxide transparent conductive films, and the power supply unit is a solar cell or a lithium battery.
